(19) United States
(12) Patent Application Publication
(10) Pub. No.: US 2017/0300521 A1
(43) Pub. Date: Oct. 19, 2017

(54) CONCURRENT ACCESSING AND PROCESSING OF DATA DURING UPGRADE

(71) Applicant: SAP SE, Walldorf (DE)

(72) Inventors: MARIUSZ DEBOWSKI, SANDHAUSEN (DE); ZAWISZA PIERZCHALSKI, HEIDELBERG (DE)

(21) Appl. No.: 15/132,210

(22) Filed: Apr. 18, 2016

(51) Int. Cl. G06F 17/30

(52) U.S. Cl. CPC G06F 17/30362; G06F 17/30339

(57) ABSTRACT

When a concurrent upgrade request is received to upgrade a database table associated with an executing application, all subsequent access requests are restricted from accessing data from the database table. The database table is freezed and a read only clone of the database table is generated. The subsequent access requests to the table are redirected to the clone table. The database table is unfreezed and the upgrade is initiated on the database table. This enables the application to read data from the clone table during the upgrade of the database table.

### FIELD

Embodiments generally relate to data processing, and more particularly to content access during concurrent execution of an application and upgrade.

### BACKGROUND

Typically, computer applications are periodically upgraded, e.g., to fix errors, improve features, add functionalities or content, etc. An upgrade may apply a number of changes to a computer application. As a result, the computer application may be in inconsistent state for a certain time period during the upgrade. For example, such inconsistent state may be reached when some of the changes are already applied, some changes are in progress while the remaining changes arc yet to be applied on the computer application. Additionally, the access to the computer application during the upgrade may be restricted, in some cases for days or even weeks. Therefore, it is challenging for the computer application to access and process data during upgrades.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a computer system allowing concurrent access of data during upgrade of a database table, according to one embodiment.

FIG. 2 is a block diagram illustrating a computer system allowing concurrent access of data during upgrade of a database table, based on alias, according to one embodiment.

FIG. 3 is a block diagram illustrating a computer system allowing concurrent access of data during upgrade of a database table, based on alias, according to one embodiment.

FIG. 4 is a block diagram illustrating a computer system allowing concurrent access of data during upgrade of a database table, as an example, according to one embodiment.

FIG. 5 is a flow diagram illustrating concurrent access of data during upgrade of a database table, according to one embodiment.

FIG. 6 is a flow diagram illustrating concurrent access of data during upgrade of a database table, according to one embodiment.

FIG. 7 is a block diagram of an exemplary computer system, according to one embodiment.

### DETAILED DESCRIPTION

Embodiments of techniques for concurrent accessing and processing of data during upgrade are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Database tables associated with computer applications may be upgraded periodically with changes to data in the database tables; or changes to structure of the database tables, e.g. addition or deletion of columns or addition of new investment product entry in a database table ‘products’. During the upgrade, the database tables may be in an inconsistent state for a certain time period. This restricts accessibility of data stored in the database tables. The proposed solution enables concurrent accessing and processing of data from the database tables during an upgrade. A concurrently executing computer application may access the database tables to execute a business process or a task. For example, in a banking application, a database table ‘products’ may be undergoing an upgrade while concurrently a customer may be able to withdraw money. A database transaction may include a sequence of database operations that may be treated as a single unit. For example, transferring money from one bank account to another bank account.

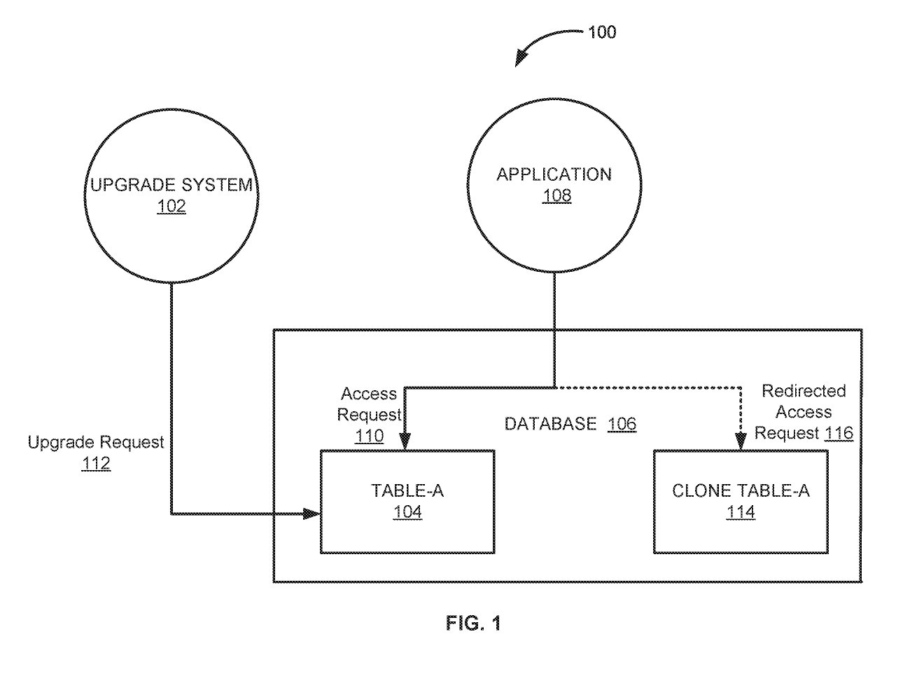

FIG. 1 is a block diagram illustrating a computer system 100 allowing concurrent access of data during upgrade of a database table, according to one embodiment. Upgrade system 102 may be connected to a repository (not shown in figure) that stores upgrade procedures and rules to trigger an upgrade. The upgrade system 102 may use rules to send command to trigger upgrade for tables, e.g., ‘table-A’ 104 stored in database 106. The database 106 may be an in-memory database where data is stored in a volatile memory such as RAM (Random access memory). A user may access application 108 to execute a business process or a task in the application 108 that requires data from the database 106. Access request 110 is received at the database 106 to access the ‘table-A’ 104 from the application 108. The application 108 may be an enterprise application, e.g., automated billing application; a standalone application, e.g., MS Access® or enterprise resource planning; a programming environment, e.g., Eclipse®, etc.

‘Table-A’ 104 may be upgraded while the concurrently executing application 108 still accesses the ‘table-A’ 104 of the database 106. Upgrade request 112 is received at the database 106 to upgrade the ‘table-A’ 104, from the upgrade system 102. The upgrade request 112 may include changes to the ‘table-A’ 104 that are applied to the ‘table-A’ 104 during the upgrade.

When the upgrade request 112 is received, it may initiate the upgrade on the ‘table-A’ 104 by initiating a sequence of database transactions. An exclusive lock is applied on the ‘table-A’ 104. Exclusive lock applied on a table, restricts subsequent access requests from accessing data in the ‘table-A’ 104 until the exclusive lock is removed or deleted. A read-only clone of the ‘table-A’ 104 is generated, e.g. ‘clone table-A’ 114, in the database 106.

After the generation of the ‘clone table-A’ 114, the access request 110 from the application 108 to the ‘table-A’ 104 is redirected to the ‘clone table-A’ 114 as redirected access request 116. The redirected access request 116 enables the application 108 to access data in the ‘clone table-A’114. For example, when the access request 110 is received from the application 108 to read data from the ‘table-A’ 104, it is redirected to the ‘clone table-A’ 114 as the redirected access request 116. When the access request 110 is received from the application 108 to write data to the ‘table-A’ 104, an error message may be displayed in a user interface associated with the application 108.

In order to continue the upgrade, the exclusive lock applied on the ‘table-A’ may be removed or deleted. Changes to the ‘table-A’ 104 are identified based on the upgrade request 112 received. The ‘table-A’ 104 is modified with the identified changes during the upgrade. For example, in a banking application, the upgrade request 112 may change a table ‘product’ by adding a new column such as ‘maximum number of permitted transactions’ during the upgrade. While the table ‘product’ is upgraded, the application 108 is able to access data in a clone table ‘clone_product’ with the help of redirected access request 116. In one database transaction, execution of following actions may take place: (a) applying an exclusive lock on the ‘table-A’ 104, and (b) generating read-only ‘clone table-A’ 114 of the ‘table-A’ 104. Upon receiving another access requests, e.g. second access request or third access request, during execution of the one database transaction, the access request is queued until successful execution of the one database transaction.

Once the ‘table-A’ 104 is successfully upgraded based on the upgrade request 112, the upgrade system 102 may report successful completion of the upgrade to the computer system 100, the application 108 may be allowed to access data in the upgraded ‘table-A’ 104 by sending a new access request. The ‘clone table-A’ 114 may be removed or deleted from the database 106, upon completion of the upgrade. In one embodiment, the upgrade request 112 may include information to upgrade multiple tables in the database 106. The upgrade system 102 may report successful completion of the upgrade on all the tables to the computer system 100, to allow the application 108 to access data in the upgraded tables by sending the new access request.

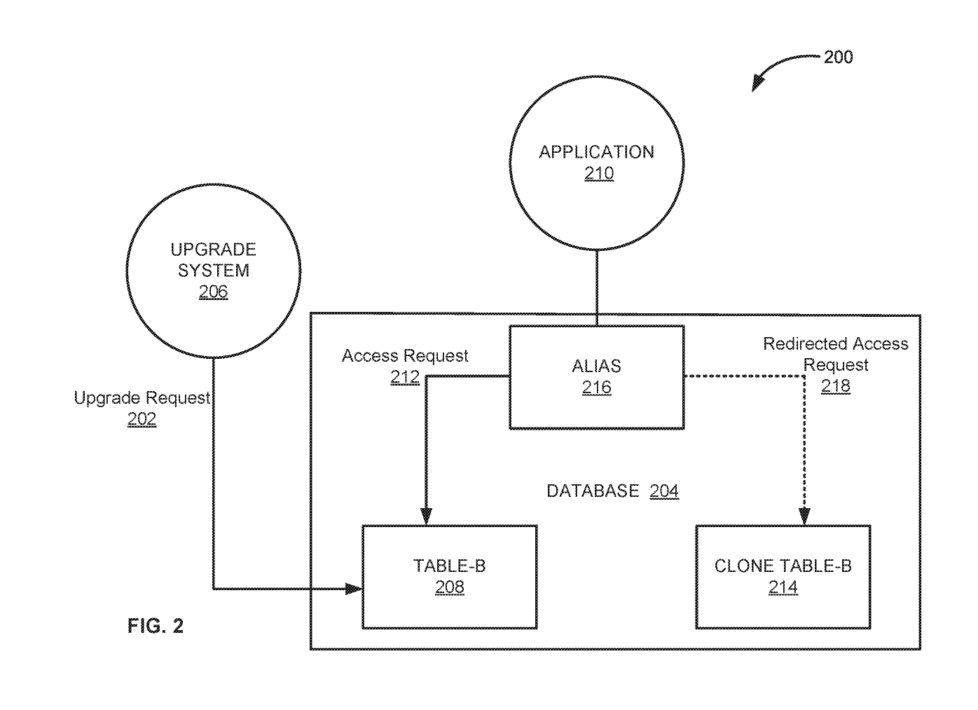

FIG. 2 is a block diagram illustrating a computer system 200 allowing concurrent access of data during upgrade of a database table, based on alias, according to one embodiment. ‘Alias’ is a temporary name provided to a database table or columns in the database table. The ‘alias’ makes the data in the database table or columns more readable than their respective technical names. For example, in a banking application, technical name of a table ‘loans’ may be ‘Loan_home_west coast US_interest_premium_D50000’. Alias ‘Loan_D50000’ may be generated pointing to the clone of table ‘Loan_home_west coast US_interest_premium_D50000’. ‘Alias’ may be part of database programming languages, e.g. SQL (structured query language). In an embodiment, database 204 receives an upgrade request 202 from upgrade system 206 to upgrade ‘table-B’ 208. Concurrently, application 210 may send access request 212 as a database transaction, to the database 204 to access content in the ‘table-B’ 208 using an alias 216. The application 210 may access data of the ‘table-B’ 208 to execute a business process or task. For example, a ‘banking application’ may access a table ‘loans’ including information about bank loans, to compute loan interest amount to be paid by a customer.

Based on the upgrade request 202 received, a sequence of database transactions may be initiated. A freeze trigger is generated on the ‘table-B’ 208. The freeze trigger allows read-only action on the content of the ‘table-B’ 208, and prevents a user or application 210 from modifying content of the ‘table-B’ 208. A read only clone of the ‘table-B’ 208 is generated, e.g. ‘clone table-B’ 214 in the database 204. Another freeze trigger is generated on the ‘clone table-B’ 214 to prevent the application 210 from modifying data in the ‘clone table-B’ 214. For example, a read-only clone of the table ‘loans’ is generated to restrict modification of data and allow read data action in the clone table. The application 210 may read data from the ‘clone table-B’ 214, since identical data from ‘table-B’ 208 has been stored in the ‘clone table-B’ 214 before the upgrade was initiated. The alias 216 pointing to the ‘table-A’ 208 initially, is regenerated pointing to the ‘clone table-B’ 214 to redirect the access request 212 from the ‘table-B’ 208 to the ‘clone table-B’ 214. The alias 216 may redirect the access request 212 as redirected access request 218. For example, in the banking application, the alias 216 may redirect the access request 212 to the read-only clone of the table ‘loans’. The application 210 may be allowed to read data in the ‘clone table-B’ 214 with the help of redirected access request 218. In one database transaction, execution of following actions may take place to redirect the access request 212: (a) the alias 216 pointing to the ‘table-B’ 208 is deleted, and (b) the alias 216 pointing to the ‘clone table-B’ 214 is regenerated. The access request 212 is redirected to the ‘clone table-B’ 214 as redirected access request 218. Execution of the one database transaction restricts any access request from the application 210 to the ‘table-B’ 208. When an access request, e.g. second access request or third access request, is received during execution of the one database transaction, the access request may be queued until successful execution of the one database transaction.

The freeze trigger generated on the ‘table-B’ 208 may restrict the upgrade request 202 to upgrade the ‘table-B’ 208. In order to initiate the upgrade on the ‘table-B’ 208, the freeze trigger is deleted from the ‘table-B’ 208. Based on the upgrade request 202 received from the upgrade system 206, changes are performed on the ‘table-B’ 208, e.g. change in loan interest rate based on asset value in the table ‘loans’. Changes to the ‘table-B’ 208 are identified during the upgrade, and then the ‘table-B’ 208 is modified based on the identified changes. Therefore, during the upgrade, there is no delay in accessing data of the ‘table-B’ 208, as the ‘clone table-B’ 214 stores data that was present in the ‘table-B’ 208 before the upgrade was initiated. On completion of the upgrade, the access request 212 is able to directly access data in the upgraded ‘table-B’ 208, and the ‘clone table-B’ 214 is removed or deleted from the database 204.

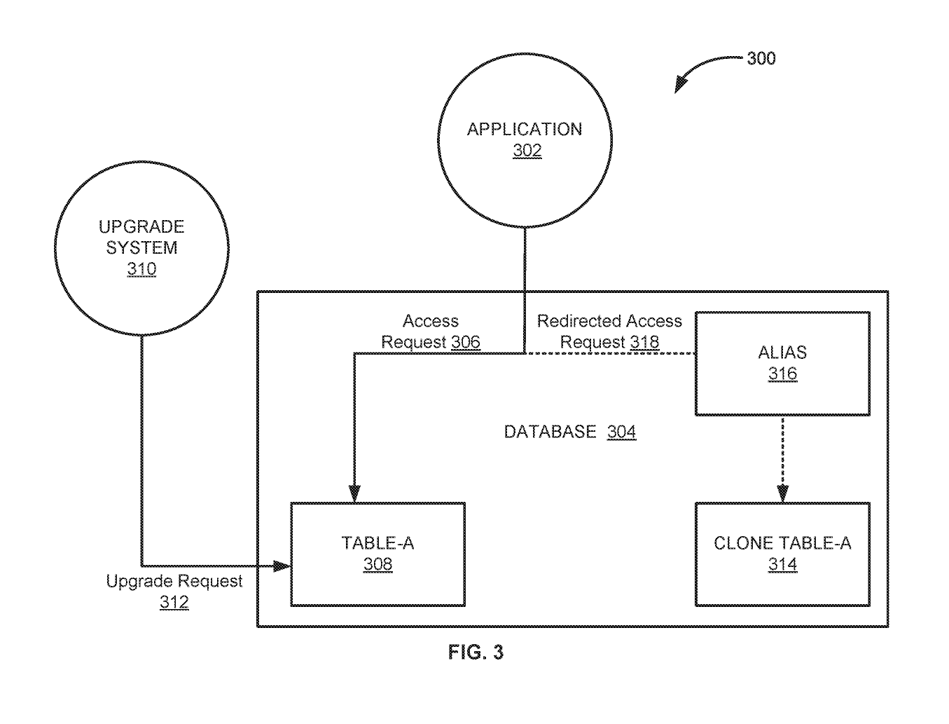

FIG. 3 is a block diagram illustrating a computer system 300 allowing concurrent access of data during upgrade of a database table, based on alias, according to one embodiment. Application 302 may directly access data stored in database 304 to execute a business process or a task. Access request 306 may be received at the database 304 to access data from a database table such as ‘table-A’ 308. For example, an enterprise application may access ‘order_details’, ‘customer’ and ‘order policy’ tables of a database for generating invoices.

Upgrade system 310 may send upgrade request 312 to upgrade the ‘table-A’ 308. The upgrade request 312 may include upgrade procedures to upgrade the ‘table-A’ 308. For example, the upgrade request 312 may include new policy structures of the current fiscal year to be included in the table ‘order_policy’ during the upgrade. The new policy structures may include information pertaining to new shipment prices or expansion of business in new locations, etc.

When the upgrade request 312 is received, a sequence of database transactions may be initiated. A freeze trigger is generated on the ‘table-A’ 308 to restrict access requests received from a user or the application 302. The freeze trigger may prevent modifying content in the ‘table-A’ 308, and allow read-only action on the ‘table-A’ 308. For example, an ‘invoice generating application’ may be allowed to perform read action to retrieve order policies data in the ‘order policy’ table based on the previous policy structures.

A clone of the ‘table-A’ 308 is generated such as ‘clone table-A’ 314. Another freeze trigger may be generated on the ‘clone table-A’ 314 to restrict requests received from the application 302. Based on the freeze trigger generated, the application 302 may be able to read but not modify the data in the ‘clone table-A’ 314.

The upgrade request 312 received from the upgrade system 310 may be in the form of a database transaction. The ‘table-A’ 308 may be renamed or given a new name. Alias 316 is generated pointing to the ‘clone table-A’ 314. The alias 316 is generated with the original name of the ‘table-A’ 308. Since, the alias 316 is to be generated with the original name of the ‘table-A’ 308, the ‘table-A’ 308 is renamed with the new name. For example, based on the upgrade request 312 received, table ‘order_policy’ may be upgraded. The table ‘order_policy’ may be renamed to ‘opolicy’. The alias 316 with the table name ‘order_policy’ is generated pointing to the clone table ‘clone_order_policy’. The alias 316 may be part of database programming languages, e.g. SQL. The alias 316 may redirect the access request 306 as redirected access request 318 to the ‘clone table-A’ 314. For example, the alias 316 may redirect the access request 306 received from the ‘invoice generating application’ to the clone table ‘clone_order_policy’. This enables the ‘invoice generating application’ to read data in the clone table ‘clone_order_policy’ to generate invoices during the upgrade.

In one database transaction, execution of following actions may take place to redirect the access request 306: (a) the ‘table-A’ 308 is renamed to the new name, and (b) alias 316 with the original name of the ‘table-A’ 308 is generated pointing to the ‘clone table-A’ 314. The access request 306 to the ‘table-A’ 308 is redirected based on the redirect access request 318 to the ‘clone table-A’ 314.

After the freeze trigger is generated on the ‘table-A’ 308, if the access request 306 received includes information to perform write action on the ‘table-A’ 308, an error message is displayed in a user interface of the application 302. When the freeze trigger is generated on ‘clone table-A’ 314, if the redirected access request 318 includes information to perform write action on the ‘clone table-A’ 314, the error message is displayed in the user interface of the application 302. After completion of the upgrade on the ‘table-A’ 308, the application 302 may directly access data in the upgraded ‘table-A’ 308, The ‘clone table-A’ 314 is removed or deleted from the database 304.

The freeze trigger generated on the ‘table-A’ 308 may restrict the upgrade request 312 to upgrade the ‘table-A’ 308. In order to initiate the upgrade on the ‘table-A’ 308, the freeze trigger is deleted from the ‘table-A’ 308. During upgrade, changes to the ‘table-A’ 308 are identified and applied to modify the ‘table-A’ 308. For example, during the upgrade, changes such as addition of new column ‘permanent/temporary clients’ may be included in the table ‘order_policy’.

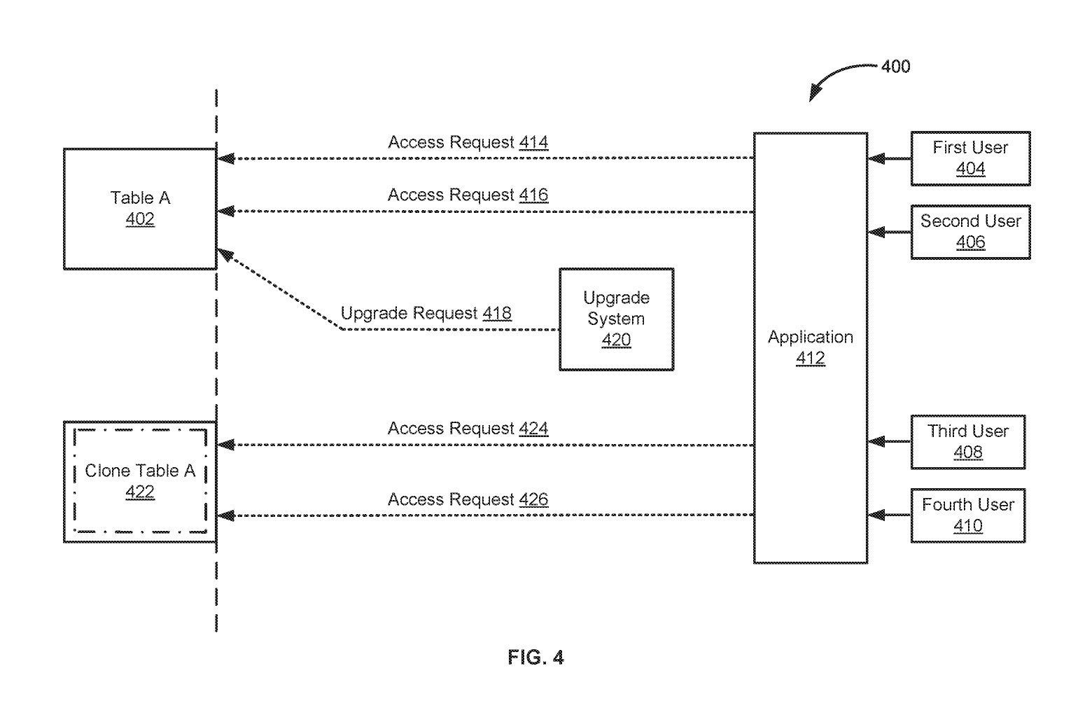

FIG. 4 is a block diagram illustrating a computer system 400 allowing concurrent access of data during upgrade of a database table, as an example, according to one embodiment. Consider ‘table A’ 402 of a database shown in figure). Users, e.g. ‘first user’ 404, ‘second user’ 406, ‘third user’ 408 and ‘fourth user’ 410 may access ‘application’ 412 to execute a business process for which data may be retrieved from the ‘table A’ 402. For example, ‘table A’ 402 may include interest rates for different bank products such as current account. The application 412 may access ‘table A’ 402 frequently to show current interest rates in a user interface associated with the application 412, when the users 404 to 410 login into the application 412. When the ‘first user’ 404 and the ‘second user’ 406 login into the application 412, access requests 414 and 416 may be sent to access data in the ‘table A’ 402. For example, the access requests 414 and 416 may fetch data, e.g. current interest rate from the ‘table A’ 402. The data fetched by the access requests 414 and 416 may be displayed in the user interface associated with the application 412.

Concurrently, upgrade request 418 may be received from upgrade system 420 to upgrade ‘table A’ 402. For example, the upgrade request may be received for table ‘loans’ to introduce new bank product and corresponding interest rates for saving accounts. When the upgrade request 418 includes write action to be performed during upgrade on the ‘table A’ 402, a read-only freeze trigger may be generated to restrict access request to the ‘table A’ 402. A read-only clone of the ‘table A’ 402 may be generated such as ‘clone table A’ 422. Until completion of the upgrade, access requests received from the application 412 may be redirected to the ‘clone table A’ 422.

When the ‘third user’ 408 and ‘fourth user’ 410 login into the application 412, access requests 424 and 426 may be received at the ‘table A’ 402 to access data. Since, the upgrade is already initiated on the ‘table A’ 402, the access requests 424 and 426 may be redirected to the ‘clone table A’ 422. The ‘clone table A’ 422 may allow read-only actions. Therefore, the proposed solution allows the concurrently executed application 412 to access data from the ‘clone table A’ 422 when the ‘table A’ 402 is upgraded with changes, e.g. new hank products and corresponding interest rates.

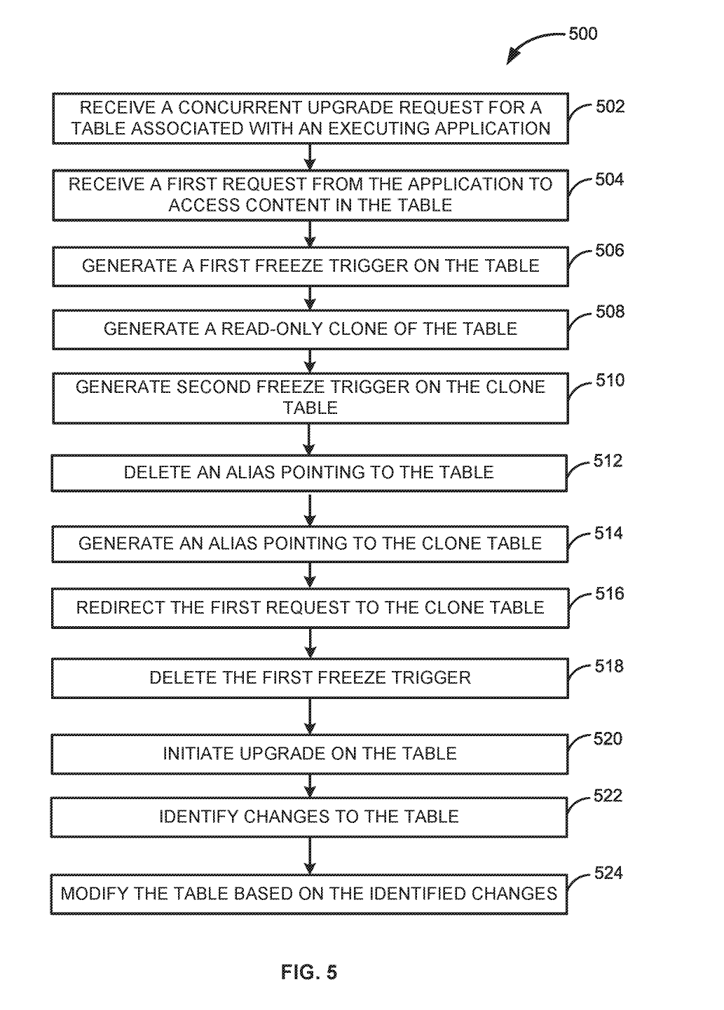

FIG. 5 is a flow diagram 500 illustrating concurrent access of data during upgrade of a database table, according to one embodiment. At 502, a concurrent upgrade request is received for a table associated with an executing application. The table may be stored in a database. At 504, a first request is received from the application to access content in the table. The application may be accessed by users to execute a business process or a task. At 506, based on the upgrade request received, a first freeze trigger is generated on the table to accept read-only requests to the table. This may restrict the application accessed by users, to modify content in the table. At 508, a clone table is generated as a read-only clone of the table. At 510, a second freeze trigger is generated on the clone table to freeze the subsequent access requests to the clone table. This may restrict the application accessed by the users, to modify content in the clone table. At 512, an alias pointing to the table is deleted. At 514, an alias pointing to the clone table is being generated. Blocks 512 to 514 may be executed in one database transaction. At 516, the first request received at the table is redirected to the clone table based on the alias regenerated in block 514, so that the table may be upgraded concurrently based on the upgrade request received. At 518, the first freeze trigger that was generated earlier on the table is deleted. The table upgrade is explained in blocks 520 to 524. At 520, based on the upgrade request received, the upgrade is initiated on the table. At 522, subsequent to 520, during the upgrade, changes to the table are identified. At 524, the table is modified with the identified changes during the upgrade. Therefore, during upgrade of a table, there is no delay in concurrently accessing the table. After completion of the upgrade, the application may be able to access content in the upgraded table. During execution of the one database transaction, if another access request is received from the application to access content in the table, the another access request may be queued until successful execution of the one database transaction.

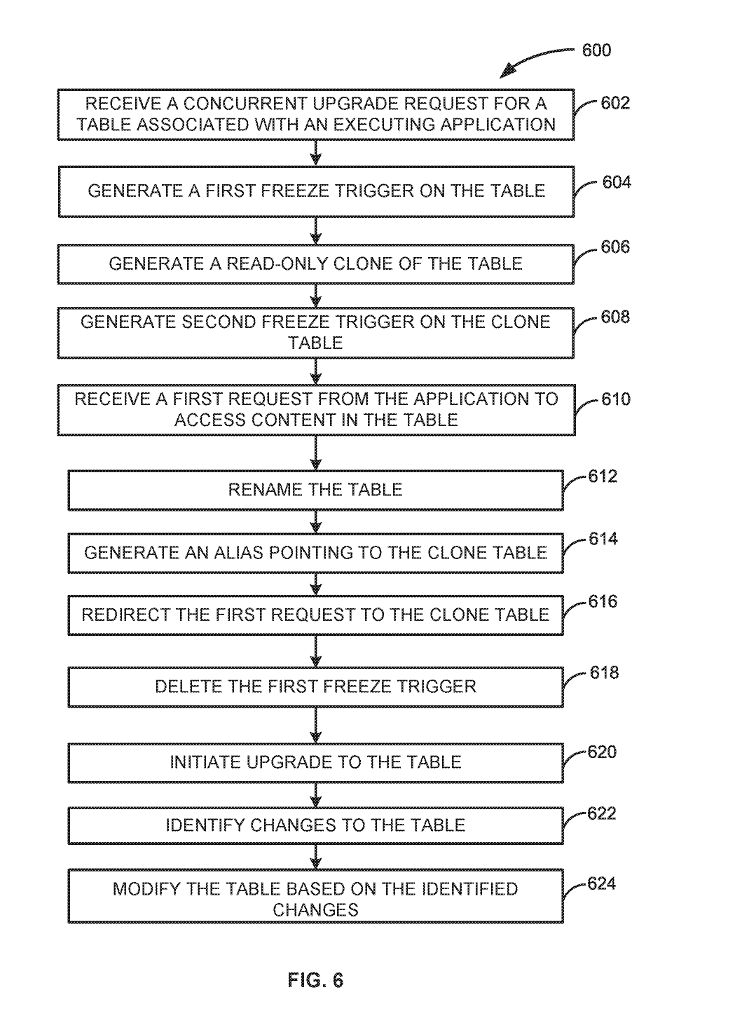

FIG. 6 is a flow diagram 600 illustrating concurrent access of data during upgrade of a database table, according to one embodiment. At 602, a concurrent upgrade request is received for a table associated with an executing application. The table may be identified with a table name stored in a database. At 604, based on the upgrade request received, a first freeze trigger is generated on the table. The first freeze trigger may restrict the application to modify content in the table, e.g. the first freeze trigger may restrict inserting new tuple or deleting existing tuples in the table. At 606, a clone table is generated as a read-only clone of the table. At 608, a second freeze trigger is generated on the clone table. The second freeze trigger may restrict the application in modifying content in the clone table. At 610, first request is received from the application to access content in the table At 612, the table is renamed to a new name. At 614, an alias is generated pointing to the clone table by naming the alias with the table name. Blocks 612 to 614 may be executed in one database transaction, to redirect the access requests to the clone table. At 616, the first request received at the table is redirected to the clone table, so that the original table may be upgraded concurrently based on the upgrade request received. At 618, the first freeze trigger that was generated on the table earlier is deleted. The table upgrade is explained in blocks 620 to 624. At 620, based on the upgrade request received, the upgrade is initiated on the table. At 622, subsequent to 620, during the upgrade, changes to the table are identified. At 624, the table is modified with the identified changes, during the upgrade. Therefore, during upgrade of a. table, there is no delay in concurrently accessing the table. After completion of the upgrade, the application may be able to access content in the upgraded table. During execution of the one database transaction, if another access request is received from the application to access content in the table, then the another access request may be queued until successful completion of the one database transaction.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or sonic other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

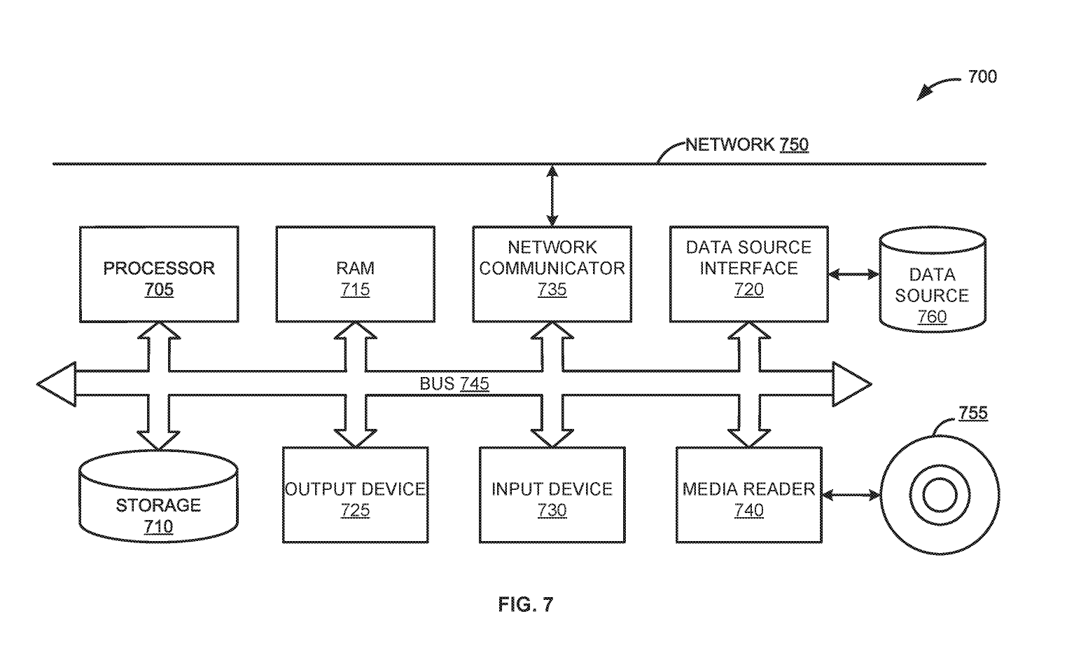

FIG. 7 is a block diagram of an exemplary computer system 700, according to one embodiment. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data. foundations, semantic layers, management systems, security systems and so on.

In the above description, numerous specific details are set forth to provide a thorough understanding of embodiments. Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described. herein for illustrative purposes, various equivalent modifications are possible within the scope of the one or more embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for concurrent access of data during upgrade, the method comprising:
receiving a first request to access content in a table, associated with an application, using an alias;
concurrently, receiving an upgrade request for the table;
freezing the table from being modified;
generating a clone table as read-only clone of the table; and
in one database transaction:
deleting an alias pointing to the table; and
generating an alias pointing to the clone table.

2. The computer implemented method according to claim 1, wherein the method further comprises:
redirecting the first request to the clone table.

3. The computer implemented method according to claim 1, wherein the method further comprises:
unfreezing the table.

4. The computer implemented method according to claim 1, wherein based on the upgrade request received, the method further comprises:
initiating upgrade on the table;
identifying changes to the table; and
modifying the table with the identified changes.

5. The computer implemented method according to claim 1, wherein the method further comprises:
receiving a second request to access content in the table; and
based on the second request, access content in the table after upgrade completion on the table.

6. The computer implemented method according to claim 1, wherein the method further comprises:
receiving a third request to access content in the table during the one database transaction; and
queuing the third request to access content in the table until completion of the one database transaction.

7. A non-transitory computer readable storage medium to tangibly store instructions, which when executed by a computer, cause the computer to provide concurrent access of data during upgrade:
receive an access request to access content in a table, associated with an application;
concurrently, receive an upgrade request for the table;
generate an exclusive lock to the table;
generate a clone table as read-only clone of the table; and
redirect the access request to the clone table.

8. The non-transitory computer readable medium according to claim 7, wherein the exclusive lock restricts access requests from accessing data in the table until the exclusive lock is deleted.

9. The non-transitory computer readable medium according to claim 7, further comprising instructions which when executed by the computer further causes the computer to:
delete the exclusive lock on the table.

10. The non-transitory computer readable medium according to claim 7, further comprising instructions which when executed by the computer further causes the computer to:
based on the received upgrade request:
initiate upgrade on the table;
identify changes to the table; and
modify the table with the identified changes.

11. A computer system for concurrent access of data during upgrade, the system comprising:
a memory to store a program code;
a processor communicatively coupled to the memory, the processor configured to execute the program code to:
receive a first request to access content in a table, associated with an application;
concurrently, receive an upgrade request for the table, wherein the table is identified with a table name;
freeze the table from being modified;
generate a clone table as read-only clone of the table; and
in one database transaction:
rename the table to a new table name; and
generate an alias pointing to the clone table by naming the clone table with the table name.

12. The computer system according to claim 11, wherein the processor executes the program code to:
redirect the first request to the clone table.

13. The computer system according to claim 11, wherein the processor executes the program code to:
unfreeze the table.

14. The computer system according to claim 11, wherein the processor executes the program code to:
based on the received upgrade request:
initiate upgrade on the table;
identify changes to the table; and
modify the table with the identified changes.

15. The computer system according to claim 1, wherein the processor executes the program code to:
receive a second request to access content in the table; and
based on the second request, access content in the table after upgrade completion on the table.

16. The computer system according to claim 11, wherein the processor executes the program code to:
receive a third request to access content in the table during the one database transaction; and
queuing the third request to access content in the table until completion of the one database transaction.
